(19) United States
(12) Patent Application Publication
(10) Pub. No.: US 2024/0037515 A1
(43) Pub. Date: Feb. 1, 2024

(54) GRAPHICAL USER INTERFACE AND CARD SYSTEM FOR ENGAGING IN CRYPTOCURRENCY TRANSACTIONS

(71) Applicant: Truist Bank, Charlotte, NC (US)

(72) Inventors: Oneka Williams, Atlanta, GA (US); Chuong Dinh, Atlanta, GA (US); Gregory Phillips, Atlanta, GA (US)

(73) Assignee: Truist Bank, Charlotte, NC (US)

(21) Appl. No.: 17/876,654

(22) Filed: Jul. 29, 2022

(51) Int. Cl. G06Q 20/06; G06Q 20/36

(52) U.S. Cl. CPC G06Q 20/065; G06Q 20/363

(57) ABSTRACT

The present disclosure relates to a graphical user interface and card system for engaging in cryptocurrency transactions. In one example, a system can provide a graphical user interface to a user. The graphical user interface can include transaction data and an option for linking a digital wallet to an account of the user. The system can detect a selection of the option and responsively link the digital wallet to the account. The system can also link a card to the digital wallet. Thereafter, the system can receive a request associated with the user using the card to engage in a cryptocurrency transaction. Based on the link between the card and the digital wallet, the system can determine that the digital wallet is to be used to execute the cryptocurrency transaction. The system can then use the digital wallet to execute the cryptocurrency transaction and update transaction data accordingly.

### TECHNICAL FIELD

The present disclosure relates generally to cryptocurrency. More specifically, but not byway of limitation, this disclosure relates to a graphical user interface and card system for engaging in cryptocurrency transactions.

### BACKGROUND

Cryptocurrencies have recently grown in popularity. Many cryptocurrencies, such as Bitcoin and Ethereum, are digital currencies in which transactions are verified and records maintained by a decentralized system using cryptography, rather than by a centralized authority. Those records may be maintained on a blockchain or another type of distributed ledger system.

### SUMMARY

One example of the present disclosure includes a non-transitory computer-readable medium comprising program code that is executable by a processor for causing the processor to: provide a graphical user interface to a user device of a user, the graphical user interface including transaction data associated with an account of the user with a service provider, wherein the transaction data describes a plurality of non-cryptocurrency transactions facilitated by the service provider for the user, and wherein the graphical user interface includes an option for linking one or more digital wallets to the account; in response to receiving a user selection of the option, link a digital wallet to the account; link the digital wallet to a card issued to the user by the service provider, wherein linking the digital wallet to the card involves storing an association between the digital wallet and the card; and subsequent to linking the digital wallet to the card: receive a request associated with the user using the card to engage in a cryptocurrency transaction; determine that the digital wallet is to be used to execute the cryptocurrency transaction based on the stored association; in response to determining that the digital wallet is to be used to execute the cryptocurrency transaction, use the digital wallet to execute the cryptocurrency transaction on behalf of the user; and update the transaction data to describe the cryptocurrency transaction.

Another example of the present disclosure includes a method involving providing a graphical user interface to a user device of a user, the graphical user interface including transaction data associated with an account of the user with a service provider, wherein the transaction data describes a plurality of non-cryptocurrency transactions facilitated by the service provider for the user, and wherein the graphical user interface includes an option for linking one or more digital wallets to the account; in response to receiving a user selection of the option, linking a digital wallet to the account; linking the digital wallet to a card issued to the user by the service provider, wherein linking the digital wallet to the card involves storing an association between the digital wallet and the card; and subsequent to linking the digital wallet to the card: receiving a request associated with the user using the card to engage in a cryptocurrency transaction; determining that the digital wallet is to be used to execute the cryptocurrency transaction based on the stored association; in response to determining that the digital wallet is to be used to execute the cryptocurrency transaction, using the digital wallet to execute the cryptocurrency transaction on behalf of the user; and updating the transaction data to describe the cryptocurrency transaction. One or more of these operations can be implemented by one or more processors.

Yet another example of the present disclosure includes a system comprising one or more processors and one or more memories, the one or more memories including instructions that are executable by the one or more processors for causing the one or more processors to: provide a graphical user interface to a user device of a user, the graphical user interface including transaction data associated with an account of the user with a service provider, wherein the transaction data describes a plurality of non-cryptocurrency transactions facilitated by the service provider for the user, and wherein the graphical user interface includes an option for linking one or more digital wallets to the account; in response to receiving a user selection of the option, link a digital wallet to the account; link the digital wallet to a card issued to the user by the service provider, wherein linking the digital wallet to the card involves storing an association between the digital wallet and the card; and subsequent to linking the digital wallet to the card: receive a request associated with the user using the card to engage in a cryptocurrency transaction; determine that the digital wallet is to be used to execute the cryptocurrency transaction based on the stored association; in response to determining that the digital wallet is to be used to execute the cryptocurrency transaction, use the digital wallet to execute the cryptocurrency transaction on behalf of the user; and update the transaction data to describe the cryptocurrency transaction.

### BRIEF DESCRIPTION OF THE DRAWINGS

FIG. 1 shows a block diagram of an example of a system for implementing some aspects of the present disclosure.

FIG. 2 shows an example of a graphical user interface page according to some aspects of the present disclosure.

FIG. 3 shows an example of a graphical user interface page through which a user can link a digital wallet to an account according to some aspects of the present disclosure.

FIG. 4 shows an example of a graphical user interface page through which a user can assign digital wallets to cards according to some aspects of the present disclosure.

FIG. 5 shows an example of database content according to some aspects of the present disclosure.

FIG. 6 shows a graphical user interface page through which a user can purchase cryptocurrency for a digital wallet according to some aspects of the present disclosure.

FIG. 7 shows a graphical user interface page with a list of cryptocurrency and non-cryptocurrency transactions according to some aspects of the present disclosure.

FIG. 8 shows a flow chart of an example of a process for implementing some aspects of the present disclosure.

FIG. 9 shows a block diagram of a computing device usable for implementing some aspects of the present disclosure.

### DETAILED DESCRIPTION

Certain aspects and features of the present disclosure relate to a graphical user interface and card system designed to allow a user to engage in cryptocurrency transactions. For example, a service provider can issue a card to the user for use in initiating cryptocurrency transactions with third parties (e.g., entities other than the service provider and the user). The card may be a physical card, similar to a debit card, or a digital card. The user may be able to swipe the card at a physical terminal of a third party, or otherwise provide the card data to the third party, to initiate a cryptocurrency transaction with the third party. When the user initiates a cryptocurrency transaction with the third party, the service provider can receive a request associated with the transaction from the third party, identify a digital wallet associated with the user, and then execute the cryptocurrency transaction using the digital wallet on behalf of the user. In this way, the user can easily engage in cryptocurrency transactions at stores or online retailers similarly to how they engage in non-cryptocurrency transactions using a debit card or credit card.

In some examples, the service provider can provide a graphical user interface through which the user can link (e.g., directly or indirectly associate) one or more digital wallets to the user's account. The user may already have an account with the service provider, where the account is different from the digital wallet. The account may be, for example, an online account used to manage a bank account or another type of service account offered by the service provider to the user. The user can use the graphical user interface to link the one or more digital wallets to that existing account. Once a digital wallet is linked to the user's account, the user can initiate cryptocurrency transactions using the card issued by the service provider.

In some examples, the graphical user interface can provide the user with the capability to link multiple digital wallets to their account. The graphical user interface can also provide the user with the ability to customize which digital wallet is assigned to which card. If the user has a single card linked to their account, the user can select which of their multiple digital wallets is to be applied to that card. If the user has multiple cards linked to their account, the user can select which digital wallet is to be applied to each card. Different cards may be linked to the same digital wallet or to different digital wallets based on the user's customizations. In this way, the user can assign multiple digital wallets to a multiple cards through the same centralized interface. Once the cards are linked to the digital wallets, the user can use the cards to quickly and easily engage in different types of cryptocurrency transactions (e.g., transactions involving different types of cryptocurrencies such as Bitcoin and Litecoin).

Some examples described herein can significantly simplify and expedite the process of engaging in cryptocurrency transactions for individuals. For example, although cryptocurrencies have recently grown in popularity, they are still a relatively new technology and many individuals lack a basic understanding of what they are and how they function. Additionally, the processes for purchasing cryptocurrencies from an exchange, creating a digital wallet, transferring the purchased cryptocurrencies from the exchange to the digital wallet, and using the digital wallet to transact with other entities are each still technically complex. Many such processes require a level of technical sophistication that is beyond the average individual, which prevents many people from participating in the crypto ecosystem. But some examples of the present disclosure can simplify some or all of those processes by providing a graphical user interface that is designed to abstract and simplify some of those technical tasks, in combination with a card system with which many people are already familiar. This combination of features can open the door to many more individuals participating in the crypto ecosystem.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

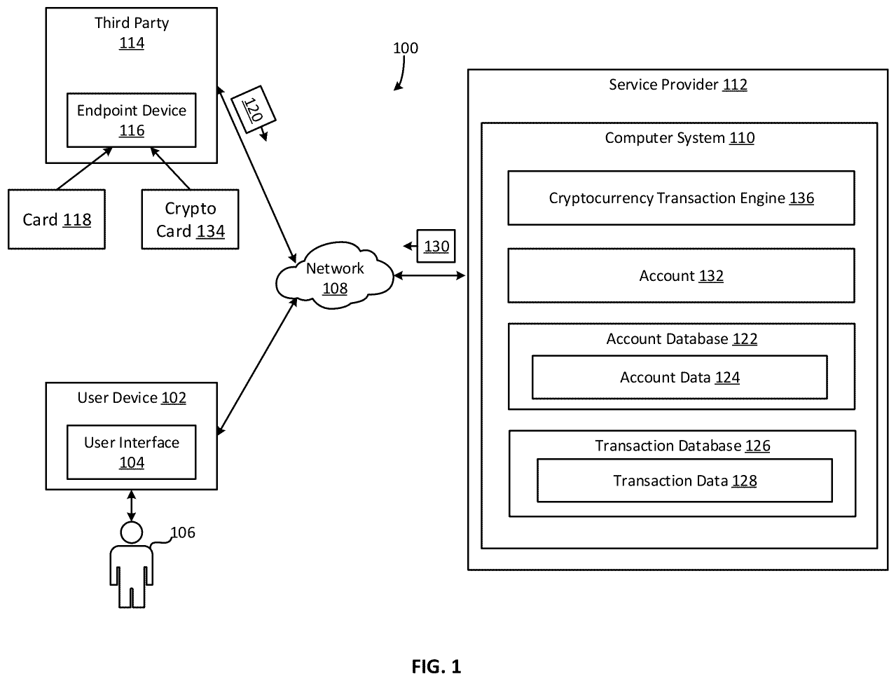

FIG. 1 is a block diagram of an example of a system 100 for implementing some aspects of the present disclosure. The system 100 includes a service provider 112 that can operate a computer system 110. In some examples, the computer system 110 may be a distributed computer system, such as a cloud computing system or a computing cluster, formed from one or more nodes (e.g., physical or virtual servers) that are in communication with one another via a network. The computer system 110 can be formed from a physical infrastructure that includes various network hardware, such as routers, hubs, bridges, switches, and firewalls. The physical infrastructure can also include one or more servers with which a user 106 can interact to perform account functions related to an account 132. The servers may provide backend support for a mobile application or may provide a web interface for enabling the user 106 to perform the account functions.

A user may establish an account 132 with the service provider 112 for use in performing various tasks. The account 132 may be of any suitable type. For example, the service provider 112 may be a bank and the account 132 may be a deposit account or checking account. The process of establishing the account 132 may require the user to fill out forms for security purposes. After establishing the account 132 with the service provider 112, the user 106 may use the account 132 to perform tasks. For example, the user 106 may use the account 132 to purchase items such as physical objects or virtual objects. Examples of the physical objects can include food, clothing, and electronics. Examples of the virtual objects can include software, videos, and music files.

In some examples, the user 106 may use the account 132 to purchase items from a third party 114 that is different from the user 106 and the service provider 112. For example, the user 106 may use a card 118 to interact with an endpoint device 116 of a third party 114 for accessing a resource provided by the third party 114. Examples of the card 118 can include a debit card or credit card. The card 118 may be a smart card with contactless technology. An example of the endpoint device 116 can be a card reader or hub. The card 118 may be linked to the account 132 and may be issued by the service provider 112. In response to the user 106 initiating a transaction with the third party 114 using the card 118, the third party 114 (e.g., a computer system of the third party 114) can transmit one or more requests 120 to the computer system 110 of the service provider 112 via one or more networks 108, such as the Internet. For example, the endpoint device 116 can transmit the requests 120 to the computer system 110. The computer system 110 can receive the requests 120 and respond by performing one or more account functions related to the account 132 to facilitate the transaction. For example, the computer system 110 can modify a balance in the account 132. Transaction data 128 describing such transactions can be stored in relation to the account 132 in a transaction database 126.

The user 106 may also deposit funds into the account 132 over time. For example, the user 106 may deposit funds into the account 132 at periodic intervals. Additionally or alternatively, an entity that is distinct from but associated with the user 106 may deposit funds into the account. One example of such an entity may be an employer of the user 106. Usage of the account 132 may result in inflows to and outflows from the account 132. Transaction data 128 describing such transactions can also be stored in relation to the account 132 in the transaction database 126.

Separately from establishing the account 132, the user 106 may register for an online account with the service provider 112 for use in monitoring and performing functions related to the underlying account 132. For example, the user 106 may go through a signup process to register an online account with the computer system 110. The user 106 may then link the online account to the underlying account 132 hosted by the service provider 112. In some such examples, the online account can be distinct from the underlying account 132 and may be used to access the computer system 110 to perform account functions related to the underlying account 132. Examples of such account functions can include checking the balance of the account, transferring funds, etc.

The user 106 can register for the online account and otherwise interact with the computer system 110 via a user device 102. Examples of the user device 102 can include a mobile phone, a laptop computer, a desktop computer, or a smart watch. The user device 102 can interact with the computer system 110 via the one or more networks 108.

In some examples, the service provider 112 can provide a user interface 104 (e.g., a graphical user interface) to the user 106 for controlling the account 132. The user 106 can access the user interface 104 by logging into the online account. This may involve the user 106 authenticating with the computer system 110. For example, the user 106 can provide a username and password associated with the online account to the computer system 110. Upon authenticating the username and password, the computer system 110 may allow the user 106 to access the user interface 104. In some cases, the user interface 104 may be part of an application (e.g., a native application) executing on the user device 102. In other cases, the user interface 104 may be part of a website accessible via a website browser. The user interface 104 may allow the user to perform account functions related to the underlying account 132 hosted by the service provider 112.

In some examples, the service provider 112 or another entity can issue a crypto card 134 to the user 106. The crypto card 134 can be a card, such as a physical card or a digital card, designed for engaging in cryptocurrency transactions. If the crypto card 134 is a physical card, it may have a similar physical shape and look to a debit card, for example so that the crypto card 134 can easily fit inside a user's physical wallet. The crypto card 134 may also be a smart card with contactless technology, in some examples.

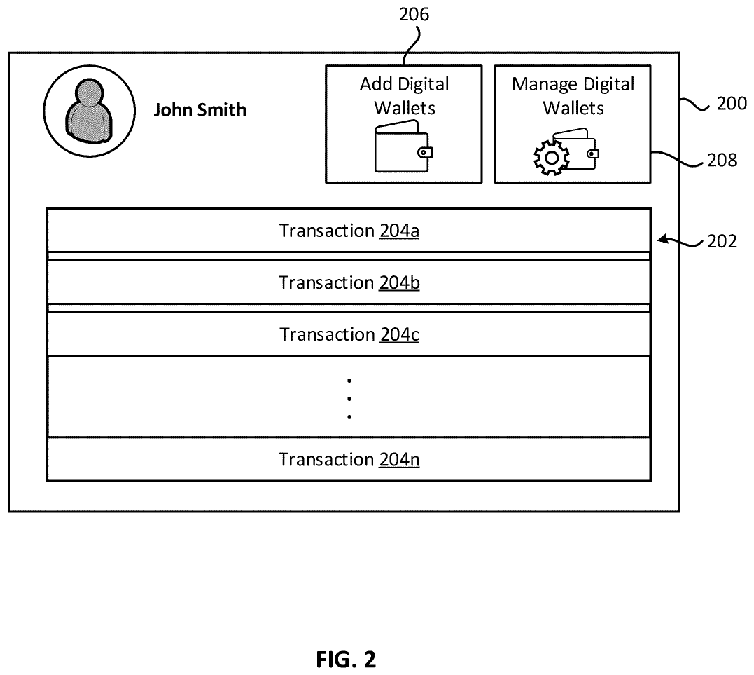

To use the crypto card 134, the user 106 may need to link a digital wallet to the crypto card 134. The user 106 may be able to do so by completing a setup process via the online account. For example, the user 106 can login to their online account to access the interface page 200 shown in FIG. 2. The interface page 200 can include a transaction list 202. Since the crypto card 143 has not yet been configured at this stage, the transaction list may include a list of non-cryptocurrency transactions 204a-n derived from the transaction data 128 in the transaction database 126. The interface page 200 can also include a first interface object 206 that is selectable to allow the user 106 to link one or more digital wallets to the online account, and a second interface object 208 that is selectable to allow the user 106 to manage the digital wallets already linked to the online account.

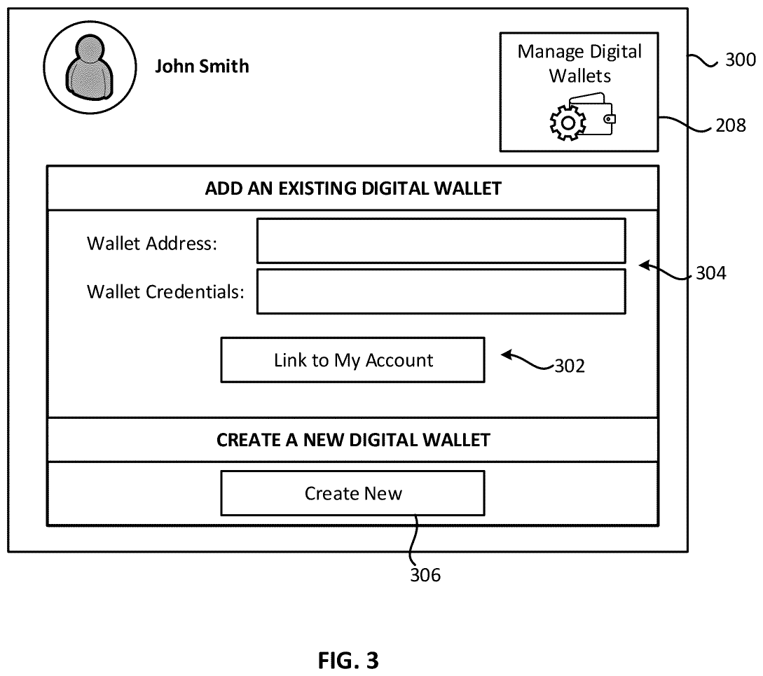

In response to the user selecting the first interface object 206, the user 106 can be presented with the interface page 300 shown in FIG. 3. Through this interface page 300, the user 106 can enter wallet information 304 for an existing digital wallet. The wallet information 304 may include a wallet address and credentials, such as a private key. For example, the user 106 or another entity may have previously created a digital wallet (e.g., using another service) and may import that digital wallet using the interface page 300. After entering the wallet information 304, the user 106 can press a button 302 to link the digital wallet to the user's online account. Once the digital wallet is linked to the online account, the service provider 112 can access and engage in cryptocurrency transactions on behalf of the user 106 using the digital wallet.

If the user 106 does not already have a digital wallet, the user 106 may alternatively press button 306 to create a new digital wallet. Pressing the button 306 can transition the user 106 to another interface page through which the user can sign up for a digital wallet. The service provider 112 can provide the backend functionality to facilitate this sign up process for the user 106, so that the user need only fill out a relatively simple form to have the digital wallet generated by the service provider 112 on the user's behalf. The service provider 112 can then link the new digital wallet to the user's online account. In this way, the service provider 112 can abstract and simplify the process of creating a new digital wallet, which may help non-technical individuals use the system.

The user 106 can repeat the above steps to link multiple digital wallets to their online account. This can indirectly link the digital wallets to the user's underlying account 132, since the account 132 and the digital wallets are all linked to the same online account of the user 106.

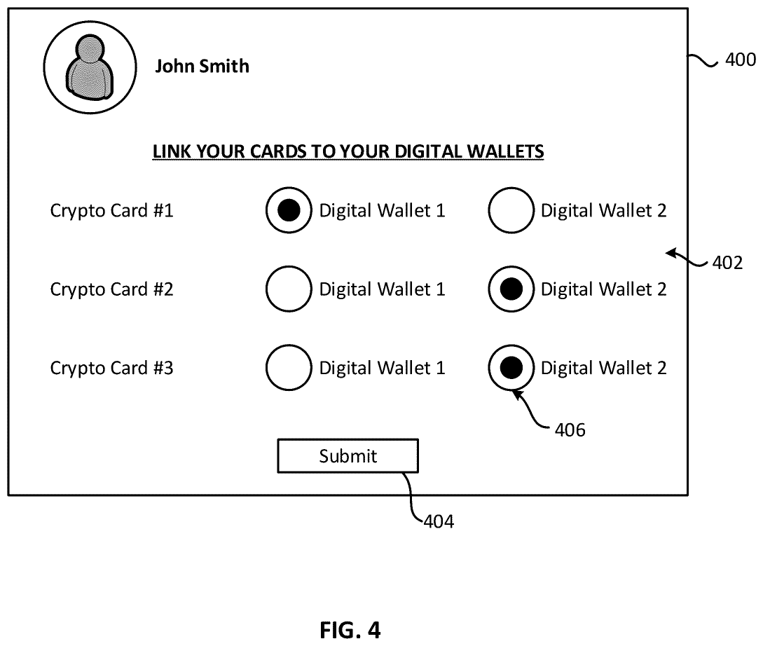

In some cases, the user 106 can have multiple crypto cards issued from the service provider 112 and/or other entities. To help manage their digital wallets and crypto cards, the user 106 can select the second interface object 208, which can bring the user 106 to the interface page 400 shown in FIG. 4. As shown, the interface page 400 can include a listing 402 of crypto cards and digital wallets linked to the user's online account. The interface page 400 can also include graphical selection elements 406, such as radio buttons, check boxes, or menus. The user 106 can interact with the graphical selection elements to selectively assign each of their crypto cards to a particular digital wallet. Multiple crypto cards can be assigned to the same digital wallet, as shown with respect to Card #2 and Card #3, or to different digital wallets, as shown with respect to Card #1 and Card #2. The user 106 can customize the assignments as desired and then press a submit button 404 to implement the customizations. For example, a first digital wallet may be configured for engaging in transactions involving Bitcoin, and a second digital wallet may be configured for engaging in transactions involving Ethereum. The user 106 can user the interface page 400 to assign a first crypto card to the first digital wallet and a second crypto card to the second digital wallet. When the user 106 then goes to purchase an item, the user 106 can select between the two crypto cards depending on whether the user wishes to pay for the item using Bitcoin or Ethereum.

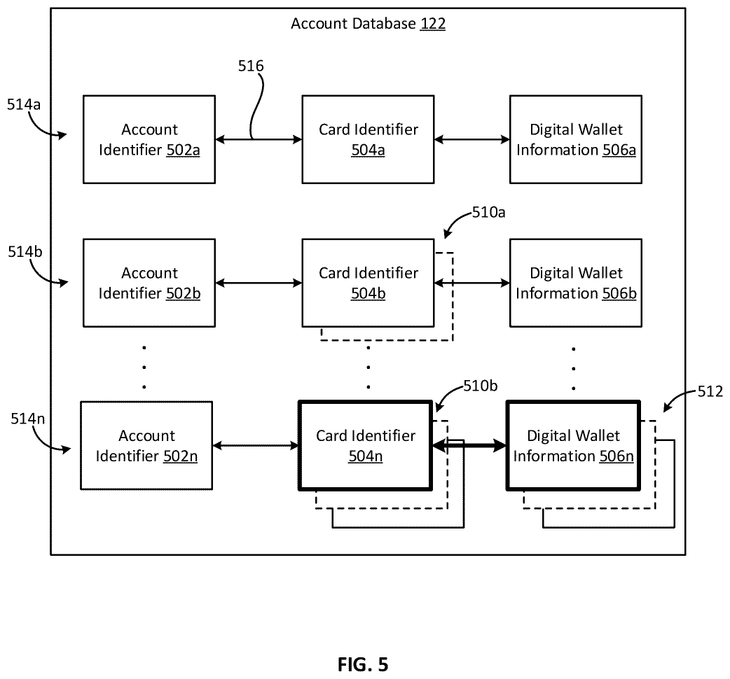

As the user 106 links digital wallets to their online account and assigns the digital wallets to crypto cards, the computer system 110 may save corresponding information in an account database 122. One example of the account database 122 is shown in FIG. 5. The account database 122 can store account data 124 including relationships 516 between account identifiers 502a-n, card identifiers 504a-n, and digital wallet information 506a-n. Each user may have a corresponding account identifier, such as an account number. The account identifier may uniquely identify an account of the user, such as the user's online account or another account 132, with the service provider 112. As shown in row 514a, the account identifier 502a can be linked to (e.g., associated with) a card identifier 504a. An example of the card identifier 504a can be a card number. The card identifier 504a can uniquely identify a corresponding crypto card 134. In this way, the crypto card for a given user can be linked to their account. The account identifier 502a and the card identifier 504a can also be linked to digital wallet information 506a. The digital wallet information 506a can correspond to a digital wallet and may include, for example, a wallet address and wallet credentials such as a private key. This can associate the digital wallet with the crypto card 134 for use in facilitating cryptocurrency transactions. The account database 122 may also store other types of account data 124 associated with users.

As noted above, in some examples the user 106 may have multiple crypto cards and a single digital wallet. An example of such an arrangement is shown in row 514b, in which there are two card identifiers 510a linked to a single set of digital wallet information 506b. This may assign both of the crypto cards to that single digital wallet. In other examples, the user 106 may have multiple crypto cards assigned to multiple digital wallets. An example of such an arrangement is shown in row 514c, in which there are three card identifiers 510b linked to three sets of digital wallet information 512. In this example, the bold card identifier is linked to the bold digital-wallet information, the dashed card identifier is linked to the dashed digital-wallet information, and the solid card identifier is linked to the solid digital-wallet information. In this way, each respective crypto card can be linked to a respective digital wallet. Although this example involves three crypto cards linked to three digital wallets, it will be appreciated that similar principles can be applied to link any number and combination of crypto cards to any number and combination of digital wallets.

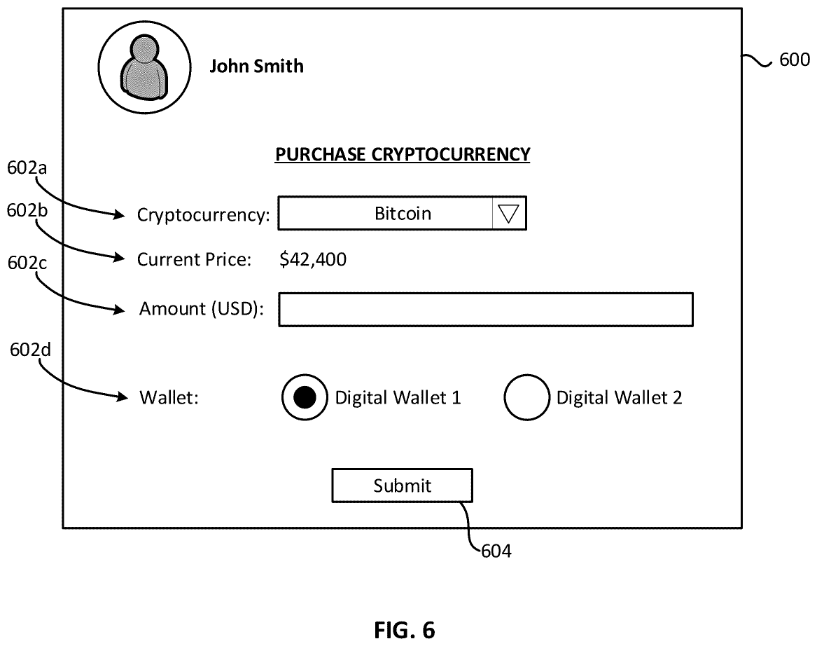

After linking a digital wallet to a crypto card 134, the user 106 may need to fund their digital wallet with cryptocurrency before the user 106 can begin to engage in cryptocurrency transactions using the crypto card 134. This may involve purchasing cryptocurrencies and transferring them to the digital wallet. In some examples, user interface 104 can also allow the user 106 to easily fund their digital wallet. For example, the user interface 104 may include interface page 600 shown in FIG. 6, though which the user 106 can purchase a cryptocurrency such as Bitcoin and store it in a selected wallet. In this example, the interface page 600 includes a selectable option 602a through which the user 106 can choose which type of cryptocurrency to purchase from among a predesignated set of cryptocurrency options. The interface page 600 also provides a current price 602b for the selected cryptocurrency. The computer system 110 can populate the current price 602b by interacting with one or more cryptocurrency exchanges via existing application programming interfaces (APIs). The interface page 600 further includes an input box 602c, in which the user 106 can designate how much of the selected cryptocurrency is to be purchased. If the user 106 has more than one digital wallet, the interface page 600 may also include graphical selection elements 602d through which the user 106 can select which of their digital wallets is to be used to store the purchased cryptocurrency. The user 106 can then press a button 604 to submit the purchase request. The computer system 110 can receive the purchase request and effectuate it using a cryptocurrency transaction engine 136. The cryptocurrency transaction engine 136 may be configured to interact with one or more cryptocurrency exchanges using APIs to facilitate the cryptocurrency purchase.

With the digital wallet now loaded with cryptocurrency, the user 106 can begin to use the crypto card 134 to purchase items or services. For example, referring back to FIG. 1, the user 106 may use the crypto card 134 to initiate a cryptocurrency transaction with a third party 114. For instance, the user 106 may use the crypto card 134 to interact with an endpoint device 116 of the third party 114. In some examples, the cryptocurrency transaction may appear similar to the third party 114 to a debit card transaction or a credit card transaction, in that the crypto card 134 may have embedded a card identifier that is similar to a debit card number of a credit card number. Thus, the transaction may be handled by the third party 114 similarly to a debit card transaction or a credit card transaction. Alternatively, the third party 114 may recognize the transaction as a cryptocurrency transaction and treat it differently than a standard debit card transaction or credit card transaction. Either way, in response to the user 106 initiating a cryptocurrency transaction with the third party 114 using the crypto card 134, the third party 114 (e.g., a computer system of the third party 114) can transmit one or more requests 120 associated with the cryptocurrency transaction to the computer system 110 of the service provider 112 via the network 108. For example, the endpoint device 116 can transmit a requests 120 associated with the cryptocurrency transaction to the computer system 110.

The computer system 110 can receive the one or more requests 120 and respond by executing the cryptocurrency transaction using a digital wallet linked to the crypto card 134. For example, the computer system 110 can use cryptocurrency transaction engine 136 to transfer an amount of cryptocurrency from the user's digital wallet to a digital wallet associated with the third party 114. An identifier of the third party's digital wallet may be embedded in the request 120, along with the amount of cryptocurrency to transfer, so that the computer system 110 knows how much cryptocurrency to transfer and the correct destination. One example of such an identifier can be a wallet address for the third party's digital wallet. Transaction data 128 describing the cryptocurrency transaction can then be stored in the transaction database 126. The computer system 110 may also transmit a notification 130 to the third party 114 regarding a status of the cryptocurrency transaction, such as whether it completed or failed.

After engaging in one or more cryptocurrency transactions, the user 106 may decide to switch which digital wallet is assigned to the crypto card 134. To do so, the user 106 may again access the user interface 104, such as interface page 400 shown in FIG. 4, and assign another digital wallet to the crypto card 134. Subsequent cryptocurrency transactions may then be implemented using the other digital wallet.

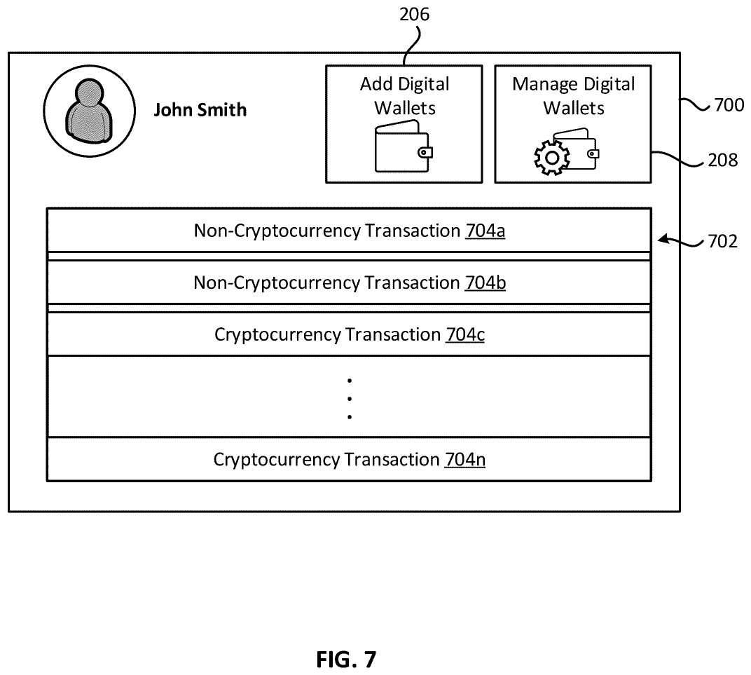

If the user 106 accesses the user interface 104 after engaging in one or more cryptocurrency transactions (using one or more of their crypto cards), the user interface 104 can present the user 106 with their updated transaction data 128. The transaction data 128 can include both cryptocurrency and non-cryptocurrency transactions. One example of this is shown in FIG. 7. As shown, the user 106 can access an interface page 700 that includes a transaction list 702. The transaction list 702 can include both non-cryptocurrency transactions 704a-b and cryptocurrency transactions 704c-n. Both types of transactions can be displayed in one unified list or interface page, so that the user 106 can easily browse all of their transactions associated with a given timeframe, such as the last month. In some examples, the user 106 can select a timeframe of interest (e.g., via a menu or another interface element) and the user interface 104 can automatically update to display the transactions within the selected timeframe. Additionally or alternatively, the user 106 may be able to filter the list 702 by transaction type, for example to only display cryptocurrency transactions or non-cryptocurrency transactions.

Through the user interface 104 described above, the user 106 may be able to quickly and easily set up a crypto card 134 to engage in cryptocurrency transactions. The user interface 104 can also allow the user 106 to quickly and easily monitor all of their transactions, including both cryptocurrency and non-cryptocurrency transactions. Such a user interface 104 may be more intuitive than existing user interfaces and may provide additional functionality that is not present in existing interfaces, such as the functionality for linking a crypto card 134 to a digital wallet. These and other features described herein can allow for average individuals to more easily participate in the crypto ecosystem.

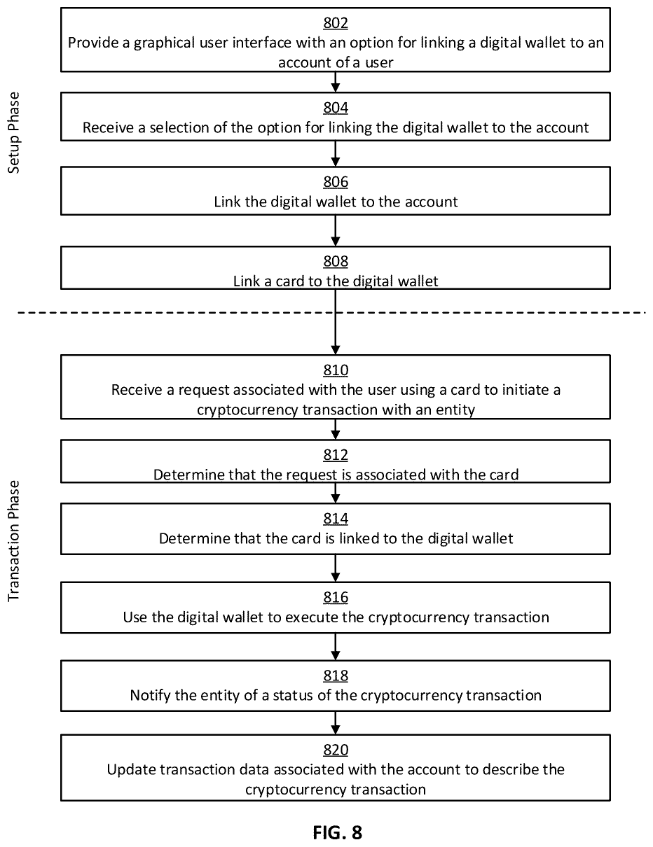

In some examples, the computer system 110 can perform the process shown in FIG. 8 to implement some aspects of the present disclosure. Other examples may include more steps, fewer steps, different steps, or a different order of the steps than is shown in FIG. 8. In general, the process shown in FIG. 8 is divided up into two phases—a setup phase that includes blocks 802-808 and a transaction phase that includes blocks 810-820. But, other phases or different phases may also be possible. The steps of FIG. 8 are described below with reference to the components of FIG. 1 describe above.

In block 802, the computer system 110 provides a graphical user interface (e.g., user interface 104) with an option for linking a digital wallet to an account of the a 106. Examples of such an option can include the first interface object 206 or the second interface object 208 shown in FIG. 2. Examples of the account can include the online account, the account 132, or another user account.

In block 804, the computer system 110 receives a selection of the option for linking the digital wallet to the account. For example, the computer system 110 can receive an electronic communication from a user device 102 of the user 106 indicating that the option has been selected.

In block 806, the computer system 110 links the digital wallet to the account, in response to receiving the selection. For example, the computer system 110 can store an association between the digital wallet and the account in a database, such as the account database 122.

In block 808, the computer system 110 links a card to the digital wallet. One example of the card can be the crypto card 134. To link the card to the digital wallet, the computer system 110 can store an association between the card and the digital wallet (or the account) in a database, such as the account database 122.

The link between the digital wallet and the card may be assigned by the computer system 110, the user 106, or another entity. For example, if the user 106 only has one crypto card 134 and only has one digital wallet, then the computer system 110 may automatically link the digital wallet to the crypto card (e.g., without any intervention by the user 106). On the other hand, if the user 106 has multiple digital wallets and/or multiple crypto cards, the user 106 can interact with the user interface 104 to manually assign digital wallets to crypto cards.

After configuring the card system, the user 106 may initiate a cryptocurrency transaction with an entity, such as the service provider 112 or a third party 114. This may trigger the transaction phase involving blocks 810-820.

In block 810, the computer system 110 receives a request 120 associated with the user 106 using a card to initiate a cryptocurrency transaction with an entity. The request 120 may be received from the entity's computer system via the network 108. The cryptocurrency transaction may be associated with purchasing goods or services from the entity. The request 120 may include transaction details for effectuating the cryptocurrency transaction. Examples of the transaction details may include a transaction amount, a destination address (e.g., a wallet address) associated with the entity to which the cryptocurrency is to be transmitted, etc.

In block 812, the computer system 110 determines that the request 120 is associated with the card. For example, the request 120 may include a card identifier for the card, thereby indicating the relationship between the request 120 and the card. The computer system 110 can extract the card identifier from the request 120 and, thereby, determine that the request 120 is associated with the card.

In block 814, the computer system 110 determines that the card is linked to the digital wallet. For example, the computer system 110 can identify a stored association between the card and the digital wallet in a database, such as the account database 122. Based on the stored association, the computer system 110 can determine that the card is linked to the digital wallet.

As another example, the computer system 110 can identify a first stored association between the card and the account in a database, such as the account database 122. Based on the first stored association, the computer system 110 can determine that the card is linked to the account. The computer system 110 can then determine that the account is linked to the digital wallet, for example based on a second stored association between the account and the digital wallet in a database. Having determined that the card is linked to the account, and the account is linked to the digital wallet, the computer system 110 can determine that the card is linked (e.g., indirectly) to the digital wallet.

In block 816, the computer system 110 uses the digital wallet to execute the cryptocurrency transaction. For example, the computer system 110 can execute a cryptocurrency transaction engine 136 to effectuate the cryptocurrency transaction using the digital wallet. In some examples, the cryptocurrency transaction engine 136 can interface with one or more blockchain networks to facilitate the cryptocurrency transaction. For example, the cryptocurrency transaction engine 136 can interact with the Bitcoin network to facilitate a Bitcoin transaction.

In block 818, the computer system 110 notifies the entity of a status (e.g., started, completed, or failed) of the cryptocurrency transaction. For example, the computer system 110 can transmit a notification 130 via the network 108 to the entity's computer system indicating the status of the cryptocurrency transaction. In some examples, the computer system 110 may transmit multiple such notifications to the entity over the course of the cryptocurrency transaction, for example, to indicate when the cryptocurrency transaction has started and completed.

In block 820, the computer system 110 updates transaction data 128 associated with the account to describe the cryptocurrency transaction. This may involve including a new transaction record associated with the cryptocurrency transaction in the transaction data 128. The new transaction record may indicate the time, date, amount, recipient, digital wallet, cryptocurrency type, and completion status associated with the cryptocurrency transaction. The new transaction record may include other transaction data as well.

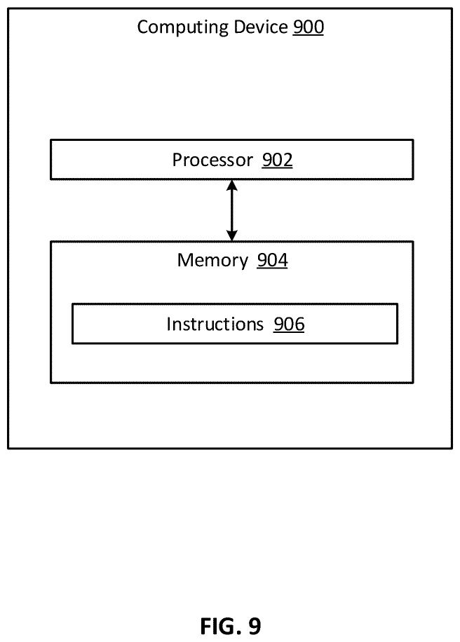

FIG. 9 shows a block diagram of a computing device 900 usable for implementing some aspects of the present disclosure. For example, the computing device 900 can be at least part of the computer system 110 or the user device 102 shown in FIG. 1.

The computing device 900 includes a processor 902 coupled to a memory 904 via a bus. The processor 902 can include one processing device or multiple processing devices. Non-limiting examples of the processor 902 include a Field-Programmable Gate Array (FPGA), an application-specific integrated circuit (ASIC), a microprocessor, or any combination of these. The processor 902 can execute instructions 906 stored in the memory 904 to perform operations. Examples of such operations can include any of the operations described above with respect to the user device 102 or the computer system 110. In some examples, the instructions 906 can include processor-specific instructions generated by a compiler or an interpreter from code written in any suitable computer-programming language, such as C, C++, C #, Python, or Java.

The memory 904 can include one memory device or multiple memory devices. The memory 904 can be non-volatile and may include any type of memory device that retains stored information when powered off. Non-limiting examples of the memory 904 include electrically erasable and programmable read-only memory (EEPROM), flash memory, or any other type of non-volatile memory. At least some of the memory device can include a non-transitory computer-readable medium from which the processor 902 can read instructions 906. A computer-readable medium can include electronic, optical, magnetic, or other storage devices capable of providing the processor 902 with computer-readable instructions or other program code. Non-limiting examples of a computer-readable medium include magnetic disks, memory chips, ROM, random-access memory (RAM), an ASIC, a configured processor, optical storage, or any other medium from which a computer processor can read the instructions 906.

The computing device 900 may also include other input and output (1/O) components, which are not shown here for simplicity. The input components can include a mouse, a keyboard, a trackball, a touch pad, a touch-screen display, or any combination of these. The output components can include a visual display, an audio display, a haptic display, or any combination of these. Examples of a visual display can include a liquid crystal display (LCD), a light-emitting diode (LED) display, and a touch-screen display. An example of an audio display can include speakers. Examples of a haptic display may include a piezoelectric device or an eccentric rotating mass (ERM) device.

It will be appreciated that all of the figures are intended to be illustrative and non-limiting. Other examples may involve more components, fewer components, different components, or a different arrangement of the components than is shown in the figures. For instance, the account database 122 and the transaction database 126 can each include any number and combination of databases. And the interface pages shown in FIGS. 2-4 and FIGS. 6-7 may include more, fewer, different, or a different arrangement of the graphical elements than is shown.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A non-transitory computer-readable medium comprising program code that is executable by a processor for causing the processor to:
provide a graphical user interface to a user device of a user, the graphical user interface including transaction data associated with an account of the user with a service provider, wherein the transaction data describes a plurality of non-cryptocurrency transactions facilitated by the service provider for the user, and wherein the graphical user interface includes an option for linking one or more digital wallets to the account;
in response to receiving a user selection of the option, link a digital wallet to the account;
link the digital wallet to a card issued to the user by the service provider, wherein linking the digital wallet to the card involves storing an association between the digital wallet and the card; and
subsequent to linking the digital wallet to the card:
receive a request associated with the user using the card to engage in a cryptocurrency transaction;
determine that the digital wallet is to be used to execute the cryptocurrency transaction based on the stored association;
in response to determining that the digital wallet is to be used to execute the cryptocurrency transaction, use the digital wallet to execute the cryptocurrency transaction on behalf of the user; and
update the transaction data to describe the cryptocurrency transaction.

2. The non-transitory computer-readable medium of claim 1, wherein the digital wallet is a first digital wallet, and further comprising program code that is executable by the processor for causing the processor to:
receive a user input for linking a second digital wallet to the account; and
in response to receiving the user input, link the second digital wallet to the account.

3. The non-transitory computer-readable medium of claim 2, further comprising program code that is executable by the processor for causing the processor to, subsequent to linking the second digital wallet to the account:
generate a graphical interface page that includes a first selectable option associated with the first digital wallet and a second selectable option associated with the second digital wallet, the graphical interface page being configured for allowing the user to select which digital wallet is to be applied to the card;
receive a selection of the second selectable option, indicating that the second digital wallet is to be applied to the card in relation to subsequent cryptocurrency transactions;
in response to receiving the selection, store a link between the second digital wallet and the card; and
based on the stored link, use the second digital wallet to execute a subsequent cryptocurrency transaction initiated using the card.

4. The non-transitory computer-readable medium of claim 1, further comprising program code that is executable by the processor for causing the processor to, subsequent to using the digital wallet to execute the cryptocurrency transaction for the user:
provide a graphical interface page to the user device, the graphical interface page including the updated transaction data associated with the account, the updated transaction data describing the cryptocurrency transaction initiated using the card and the plurality of non-cryptocurrency transactions not initiated using the card.

5. The non-transitory computer-readable medium of claim 1, wherein the cryptocurrency transaction is between the user and a third party, the third party being an entity that is different from the service provider and the user.

6. The non-transitory computer-readable medium of claim 5, further comprising program code that is executable by the processor for causing the processor to notify the third party of a status of the cryptocurrency transaction.

7. The non-transitory computer-readable medium of claim 1, further comprising program code that is executable by the processor for causing the processor to:
determine that the request is associated with the card;
based on determining that the request is associated with the card, determine that the card is linked to the digital wallet; and
based on determining that the card is linked to the digital wallet, execute the cryptocurrency transaction using the digital wallet.

8. The non-transitory computer-readable medium of claim 1, further comprising program code that is executable by the processor for causing the processor to, in response to receiving the user selection of the option:
generate a graphical interface page requesting wallet information for the digital wallet from the user;
receive the wallet information from the user; and
store the wallet information in association with the account, the wallet information including a wallet address associated with the digital wallet.

9. A method comprising:
providing, by a processor, a graphical user interface to a user device of a user, the graphical user interface including transaction data associated with an account of the user with a service provider, wherein the transaction data describes a plurality of non-cryptocurrency transactions facilitated by the service provider for the user, and wherein the graphical user interface includes an option for linking one or more digital wallets to the account;
in response to receiving a user selection of the option, linking, by the processor, a digital wallet to the account;
linking, by the processor, the digital wallet to a card issued to the user by the service provider, wherein linking the digital wallet to the card involves storing an association between the digital wallet and the card; and
subsequent to linking the digital wallet to the card:
receiving, by the processor, a request associated with the user using the card to engage in a cryptocurrency transaction;
determining, by the processor, that the digital wallet is to be used to execute the cryptocurrency transaction based on the stored association;
in response to determining that the digital wallet is to be used to execute the cryptocurrency transaction, using, by the processor, the digital wallet to execute the cryptocurrency transaction on behalf of the user; and
updating, by the processor, the transaction data to describe the cryptocurrency transaction.

10. The method of claim 9, wherein the digital wallet is a first digital wallet, and further comprising:
receiving a user input for linking a second digital wallet to the account; and
in response to receiving the user input, linking the second digital wallet to the account.

11. The method of claim 10, further comprising, subsequent to linking the second digital wallet to the account:
generating a graphical interface page that includes a first selectable option associated with the first digital wallet and a second selectable option associated with the second digital wallet, the graphical interface page being configured for allowing the user to select which digital wallet is to be applied to the card;
receiving a selection of the second selectable option, indicating that the second digital wallet is to be applied to the card in relation to subsequent cryptocurrency transactions;
in response to receiving the selection, storing a link between the second digital wallet and the card; and
based on the stored link, using the second digital wallet to execute a subsequent cryptocurrency transaction initiated using the card.

12. The method of claim 9, further comprising, subsequent to using the digital wallet to execute the cryptocurrency transaction for the user:
providing a graphical interface page to the user device, the graphical interface page including the updated transaction data associated with the account, the updated transaction data describing the cryptocurrency transaction initiated using the card and the plurality of non-cryptocurrency transactions not initiated using the card.

13. The method of claim 9, wherein the cryptocurrency transaction is between the user and a third party, the third party being an entity that is different from the service provider and the user.

14. The method of claim 13, further comprising program code that is executable by the processor for causing the processor to notify the third party of a status of the cryptocurrency transaction.

15. The method of claim 9, further comprising:
determining that the request is associated with the card;
based on determining that the request is associated with the card, determining that the card is linked to the digital wallet; and
based on determining that the card is linked to the digital wallet, executing the cryptocurrency transaction using the digital wallet.

16. The method of claim 9, further comprising, in response to receiving the user selection of the option:
generating a graphical interface page requesting wallet information for the digital wallet from the user;
receiving the wallet information from the user; and
storing the wallet information in association with the account, the wallet information including a wallet address associated with the digital wallet.

17. A system comprising:
one or more processors; and
one or more memories including instructions that are executable by the one or more processors for causing the one or more processors to:
provide a graphical user interface to a user device of a user, the graphical user interface including transaction data associated with an account of the user with a service provider, wherein the transaction data describes a plurality of non-cryptocurrency transactions facilitated by the service provider for the user, and wherein the graphical user interface includes an option for linking one or more digital wallets to the account;
in response to receiving a user selection of the option, link a digital wallet to the account;
link the digital wallet to a card issued to the user by the service provider, wherein linking the digital wallet to the card involves storing an association between the digital wallet and the card; and
subsequent to linking the digital wallet to the card:
receive a request associated with the user using the card to engage in a cryptocurrency transaction;
determine that the digital wallet is to be used to execute the cryptocurrency transaction based on the stored association;
in response to determining that the digital wallet is to be used to execute the cryptocurrency transaction, use the digital wallet to execute the cryptocurrency transaction on behalf of the user; and
update the transaction data to describe the cryptocurrency transaction.

18. The system of claim 17, wherein the digital wallet is a first digital wallet, and wherein the one or more memories further comprise instructions that are executable by the one or more processors for causing the one or more processors to:
receive a user input for linking a second digital wallet to the account; and
in response to receiving the user input, link the second digital wallet to the account.

19. The system of claim 18, wherein the one or more memories further comprise instructions that are executable by the one or more processors for causing the one or more processors to, subsequent to linking the second digital wallet to the account:
generate a graphical interface page that includes a first selectable option associated with the first digital wallet and a second selectable option associated with the second digital wallet, the graphical interface page being configured for allowing the user to select which digital wallet is to be applied to the card;
receive a selection of the second selectable option, indicating that the second digital wallet is to be applied to the card in relation to subsequent cryptocurrency transactions;
in response to receiving the selection, store a link between the second digital wallet and the card; and
based on the stored link, use the second digital wallet to execute a subsequent cryptocurrency transaction initiated using the card.

20. The system of claim 17, wherein the one or more memories further comprise instructions that are executable by the one or more processors for causing the one or more processors to:
determine that the request is associated with the card;
based on determining that the request is associated with the card, determine that the card is linked to the digital wallet; and
based on determining that the card is linked to the digital wallet, execute the cryptocurrency transaction using the digital wallet.
